(19) United States
(12) Patent Application Publication
(10) Pub. No.: US 2002/0131165 A1
(43) Pub. Date: Sep. 19, 2002

(54) Inverted microscope system

(75) Inventor: Yasuteru Takahama, Kodaira-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/091,914

(22) Filed: Mar. 6, 2002

(30) Foreign Application Priority Data
Mar. 9, 2001 (JP) 2001-066985

(51) Int. Cl. G02B 21/00; G02B 21/06

(52) U.S. Cl. 359/381; 359/368; 359/385; 359/388

(57) ABSTRACT

An inverted microscope system comprises a microscope main body having an objective lens opposed to a sample, a primary image forming optical system which forms an intermediate image of the sample in cooperation with the objective lens, and focusing section for changing a relative distance between the sample and the objective lens and forming the intermediate image of the sample at a predetermined position, illumination section, which is detachable with respect to the microscope main body, for generating illumination light to the sample, and an additional unit which is detachable with respect to the microscope main body and includes an observation tube to observe the intermediate image of the sample.

### CROSS-REFERENCE TO RELATED APPLICATIONS

This application is based upon and claims the benefit of priority from the prior Japanese Patent Application No. 2001-066985, filed Mar. 9, 2001, the entire contents of which are incorporated herein by reference.

### BACKGROUND OF THE INVENTION

1. Field of the Invention

The present invention relates to an inverted microscope system, in which an observed sample set on a stage is magnified and observed by an objective lens disposed directly under the sample.

2. Description of the Background Art

Inverted microscopes are widely used in researches in fields treating live cells, such as life science and physiology, and industrial researches and inspections such as structure observation and detection of inclusion of various metal materials.

In the meantime, an inverted microscope includes an optical system which relays an image of an objective lens in an microscope main body (hereinafter referred to as “main body”), which is different from an upright microscope. Therefore, in an inverted microscope, different dedicated main bodies are often prepared according to various uses.

For example, an inverted microscope including an optical system for obtaining a sample image for both of a large image camera (large format camera) and a small image camera (usually 35 mm camera) is disclosed (see Jpn. Pat. Appln. KOKOKU Pub. No. 57-37848). This inverted microscope has an optical system for observing and an optical system for image documentation in a U-shaped casing (main body) (hereinafter an inverted microscope having such a structure is sometimes referred to as “U-shaped”). The optical system for observing guides an intermediate image by an objective lens to an eyepiece of an observation tube (tube). The optical system for image documentation guides a sample image to be picked up to the large image camera and the small image camera. Further, the above publication discloses the case where a cine-camera (TV camera) is provided in addition to a large image camera and a small image camera. In such a case, an optical element necessary for attaching a TV camera can be attached afterwards by changing a covering plate attached to a side surface of the main body with another covering plate.

The above U-shaped inverted microscope is mainly for industrial use. In the meantime, an inverted microscope mainly for biological and medical use, which has the following structure, for example (see Jpn. Pat. Appln. KOKAI Pub. No. 7-035986 and Jpn. Pat. Appln. KOKAI Pub. No. 8-43741). A part of a beam which has passed the objective lens and a tube lens is guided by a first optical element to a horizontal-forward optical path for image documentation. The beam which has passed downward from the first optical element is guided by a second optical element to an obliquely-forwarded optical path for observing (hereinafter an inverted microscope having such a structure is sometimes referred to as “V-shaped”).

In recent years, to perform various researches and analyses, a demand for combining plural kinds of devices, such as a cooled CCD camera, photodiode array and digital camera, not only one kind, with an optical microscope is greatly increasing. To meet such a demand, it is required to increase the number of optical paths for image documentation, and provide proper optical systems adapted to respective image pickup means, specifically as follows.

For example, in biological and medical use, a microscope is required to detect microscopic weak light, such as in weak fluorescence observation and weak photometry, which cannot be detected by human eyes. Therefore, a bright optical system with least deterioration of image due to relay, etc., is required. Further, in industrial use, in addition to a demand concerning deterioration of image and brightness, an optical system having the following feature is desired. For example, to measure dimensions and area of a specific part of a sample, an intermediate image is formed and a scale is imprinted therein. Further, the image is relayed with magnification varied to magnify it to a proper size.

Therefore, it is an important subject for manufacturers of microscopes how to satisfy these various demands. It is not preferable in respect of costs to manufacture many kinds of dedicated main bodies of inverted microscope in accordance with its use, as in prior art.

Suppose that the above U-shaped inverted microscope is used for biological and medical use. There are cases where a large image camera and small image camera on the front surface of the main body become unnecessary, by preparing plural ports which can pickup a primary image of a sample formed in the vicinity of a semi-transparent mirror directly under the objective lens. Further, even in the case where it is applied to its original use, that is, industrial use, both the large image camera and small image camera are not always used. For example, there are cases where only a TV camera is used, and there can be cases of requiring no optical systems for projecting a sample image on each of the large image camera and small image camera. Therefore, a conventional U-shaped inverted microscope is not regarded as being advantageous in respect of costs.

In the meantime, in a V-shaped inverted microscope, a 35 mm camera is disposed on an optical path for image documentation through which a beam reflected by the first optical element. Therefore, if a large-sized camera or a TV camera is desired to be attached to the optical path for image documentation, it is necessary to change the optical system to an optimum optical system for image documentation having different magnification, etc. However, since the form of the microscope main body has already been determined, an optimum optical system cannot be always achieved. Further, as described above, there are cases where an optical path for image documentation for a 35 mm camera is unnecessary. In such a case, a structure of the microscope main body for forming an image pickup port for attaching a 35 mm camera to the microscope main body is unnecessary. If the optical path for image documentation on the front side of the microscope main body is unnecessary, naturally a footprint (desk occupation area) on the front side of the inverted microscope main body can be reduced. However, since the form of the microscope main body is originally predetermined to provide an image pickup optical path, the footprint cannot be reduced.

As described above, a main body of each of conventional inverted microscopes is formed integrally so as to be adapted to its use, such as industrial use and biological and medical use. Therefore, it is difficult to make a structure which can be applied to all uses.

### BRIEF SUMMARY OF THE INVENTION

The object of the present invention is to provide an inverted microscope system which can be flexibly applied to various uses.

An inverted microscope according to an aspect of the present invention is characterized by comprising: a microscope main body having an objective lens opposed to a sample, a primary image-forming optical system which forms an intermediate image of the sample in cooperation with the objective lens, and focusing means for changing a relative distance between the sample and the objective lens and forming the intermediate image of the sample at a predetermined position; illumination means, which is detachable with respect to the microscope main body, for generating illumination light to the sample; and an additional unit which is detachable with respect to the microscope main body and includes a tube to observe the intermediate image of the sample.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principle of the invention.

FIG. 1 is a diagram showing a schematic structure of an inverted microscope applied to biological and medical use according to a first embodiment of the present invention;

FIG. 2 is a diagram showing a schematic structure of an inverted microscope applied to industrial use according to the first embodiment;

FIG. 3 is a diagram showing a schematic structure of an inverted microscope applied to industrial use according to the first embodiment;

FIG. 4 is a diagram showing another structure of a reflection mirror used in the embodiments of the present invention;

FIG. 5 is a diagram showing a schematic structure of an inverted microscope according to a second embodiment, in which the option unit is added;

FIG. 6 is a diagram showing a schematic diagram of an inverted microscope according to the second embodiment, in which the option unit is added;

FIG. 7 is a diagram showing a schematic diagram of an inverted microscope according to a third embodiment of the present invention, in which a photographic device is added; and

FIG. 8 is a diagram showing a schematic diagram of an inverted microscope according to the third embodiment, in which the photographic device is added.

### DETAILED DESCRIPTION OF THE INVENTION

Embodiments of the present invention will be described with reference to the drawings.

(First Embodiment)

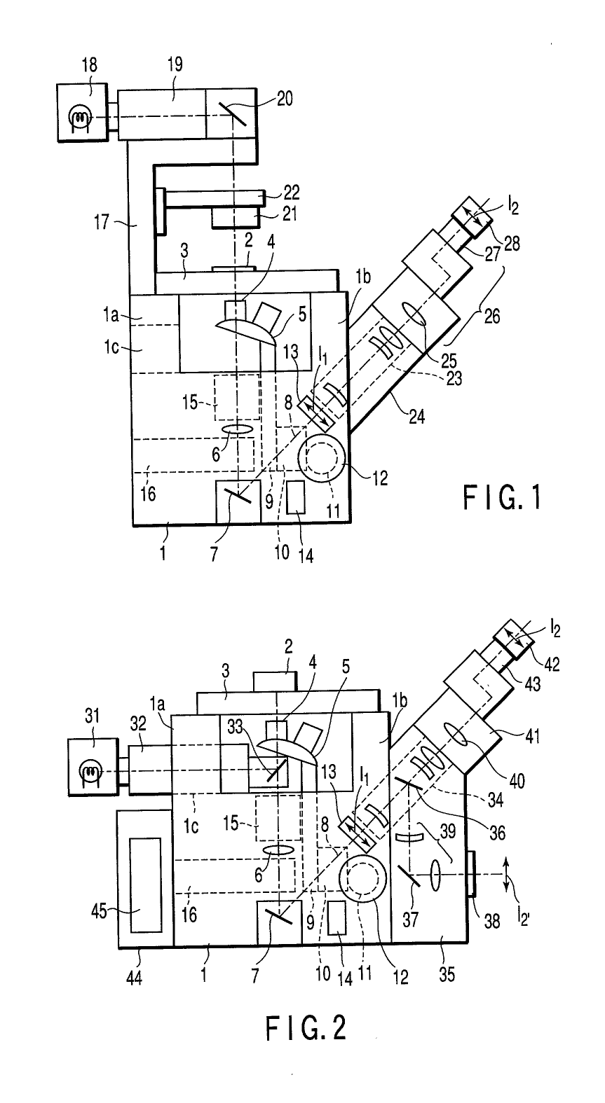

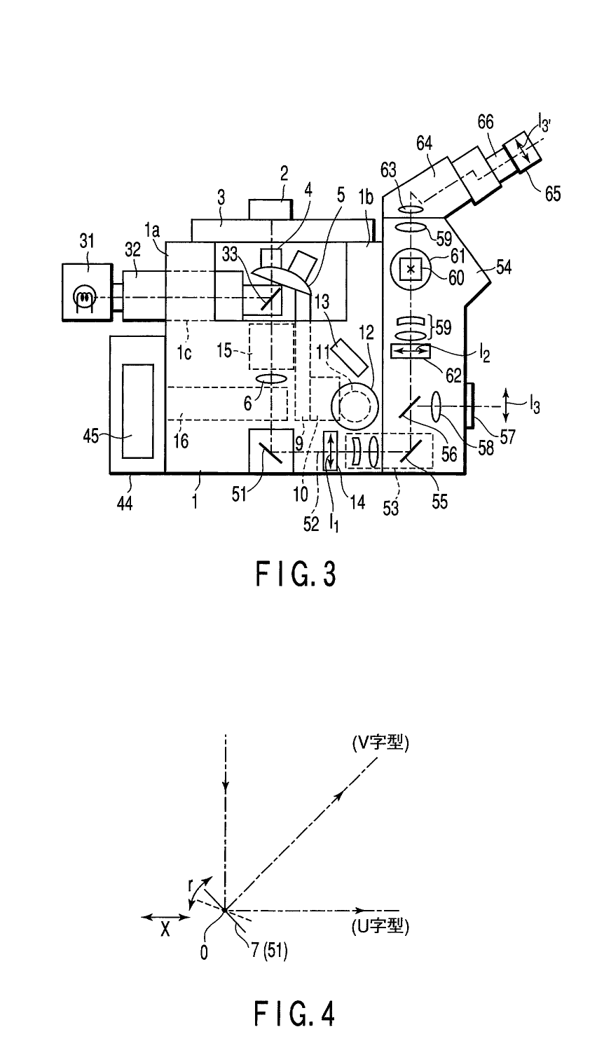

FIGS. 1 to 3 show a schematic structure of the inverted microscope system according to a first embodiment of the present invention. The inverted microscope according to the first embodiment is characterized by comprising a common microscope main body (hereinafter referred to as “main body”). In FIGS. 1 to 3, a unit to be mounted on the main body is changed according to its use. Specifically, an attachable/detachable additional unit is mounted on the main body to form a microscope adapted to individual uses. FIG. 1 is a diagram showing an inverted microscope applied to biological and medical use. FIGS. 2 and 3 are diagrams each showing an inverted microscope applied to industrial use.

First, a main body 1 will be explained. A pair of leg portions la and lb projecting upward are formed on the front and rear positions of an upper portion of the main body 1, and thereby the main body 1 is formed to have an almost concave shape. A stage 3 is disposed above the leg portions la and lb. An observed sample 2 is placed on the stage 3.

Plural objective lenses 4 are arranged under the observed sample 2 via the stage 3. The plural objective lenses 4 are held by a revolver 5, and one of the plural objective lenses 4 is interchangeably disposed on an observation optical path of the observed sample 2 placed on the stage 3.

A tube lens 6 forming a primary image forming optical system is disposed on an optical axis of the objective lens 4 disposed on the observation optical path. The tube lens 6 cooperates with the objective lens 4 to form a magnified image of the observed sample 2. Further, an imaging beam of the observed sample 2 outgoing from the objective lens 4 and tube lens 6 is made incident on a reflection mirror 7. The reflection mirror 7 is disposed on the bottom portion of the main body 1. The imaging beam made incident from the tube lens 6 is reflected by the reflection mirror 7 obliquely upward. Further, the imaging beam forms an intermediate image I1 on an observation optical path 8 after reflection by the reflection mirror 7.

The revolver 5 is held by a revolver stand 9. The revolver stand 9 is supported so as to be direct-acting vertically with respect to the main body 1. Further, a rack 10 is attached to the revolver stand 9. A pinion shaft 11 which meshes with the rack 10 is provided coaxially with focusing handles 12. When focusing handles 12 are rotated, the pinion shaft 11 rotates. Then, the rack 10 which meshes with the pinion shaft 11 and the revolver stand 9 fixed on the rack 10 are vertically driven. Therefore, a relative distance between the observed sample 2 placed on the stage 3 and the objective lens 4 held by the revolver 5 changes. Thereby, it becomes possible to perform focusing to image the intermediate image I1 of the observed sample 2 formed by the objective lens 4 and the tube lens 6 at a predetermined position. This focusing mechanism is called “focusing mechanism”.

In FIGS. 1 and 2, the revolver stand 9 and rack 10 appear to intercept the observation optical path 8 directed obliquely upward. However, the revolver stand 9 and rack 10 are off from the observation optical path 8 in the right/left direction of the main body 1 (that is, in the vertical direction perpendicular to the surface of sheet of FIGS. 1 and 2). Therefore, the revolver stand 9 and rack 10 do not intercept the observation optical path 8.

The pinion shaft 11 is disposed so as to penetrate the main body 1 in the lateral direction. The focusing handle 12 is provided on each end portion of the pinion shaft 11 projecting from the side surfaces of the main body 1. The focusing handles 12 and the pinion shaft 11 are arranged in a region held between the observation optical path 8 directed obliquely upward shown in FIGS. 1 and 2 and an observation optical path 52 (the details of which is described later) directed in a practically horizontal direction shown in FIG. 3. Therefore, the pinion shaft 11 intercepts neither the observation optical path 8 nor the observation optical path 52. Thus, it is possible to use either of the observations optical paths 8 and 52 according to the use.

The main body 1 comprises an opening portion 1c for mounting an illuminator (tube) 32 for incident-light illumination described later, on the leg portion 1a. Slots 13 and 14 are formed to insert a scale for measuring partial dimensions of the sample and a framing reticle indicating a range reflected in the photographic device at a position of the intermediate image I₁ of the observed sample 2. Further, an option unit adding space 15 is formed across the optical path between the objective lens 4 and the tube lens 6 and along the width direction of the main body 1 (the direction perpendicular to the surface of sheet). In addition, another option unit adding space 16 is formed across the optical path between the tube lens 6 and the reflection mirror 7 and along the longitudinal direction of the main body 1. Predetermined functions are achieved by mounting respective predetermined option units on the opening portion 1c, slots 13 and 14 and option unit adding spaces 15 and 16, in various special uses of inverted microscopes as described later.

The above is a schematic structure of the main body 1 which is used in common.

In the inverted microscope shown in FIG. 1 for biological and medical use, the following additional units are mounted on the main body 1.

A strut 17 is provided on the leg portion la on the rear side of the main body 1. The strut 17 supports an illuminator tube 19 having a light source device 18 using a halogen lamp, etc. as transillumination means. The illuminator tube 19 is provided with a mirror 20. The mirror 20 reflects illumination light guided horizontally from the light source device 18 to the illuminator tube 19 vertically downward. The strut 17 supports a condenser receiver 22 holding a condenser lens 21. The condenser lens 21 condenses the illumination light reflected by the mirror 20 onto the observed sample 2. Further, the condenser receiver 22 is vertically movable along the strut 17. Furthermore, as described above, the reflection mirror 7 disposed at the bottom portion of the main body 1 reflects an imaging beam of the observed sample 2, which has outgone vertically downward by the objective lens 4 and imaging lens 6 in an obliquely upward direction (45° in this case). Then, the intermediate image I1 is formed on the observation optical path 8.

The intermediate image I1 is made incident on a relay lens group 23 serving as a relay optical system. The relay lens group 23 is arranged in a hollow portion of a cylindrical additional unit 24 provided on the front side of the main body 1 in an obliquely upward direction. The optical axis of the relay lens group 23 agrees with the optical axis of the observation optical path 8. A hole portion enough for the relay lens group 23 to enter the main body 1 is provided on the main body 1 side. A part of the relay lens group 23 enters the main body 1 side through the hole portion.

A tube 26 is detachably attached to the distal end portion of the additional unit 24. The tube 26 has a tube lens 25 for imaging a parallel beam from the relay lens group 23. Further, a binocular portion 27 for observation by both eyes is provided integrally on the tube 26. An eyepiece 28 is attached to the binocular portion 27. Thereby, the imaging beam from the tube lens 25 is imaged as a first image I2 at the position of the eyepiece 28. Then, the imaging beam enters the observer's eyes through the eyepiece 28 to be visually observed.

In the inverted microscope for biological and medical use as described above, when transillumination light from the light source device 18 is irradiated from the illuminator tube 19 on the observed sample 2 via the mirror 20, the sample image is visually observed by the observer as follows. The intermediate image I1 of the observed sample 2 located on the optical axis of the objective lens 4 is formed on the observation optical path 8 by the objective lens 4 and the tube lens 6. Thereafter, the intermediate image I1 is formed as the first image I2 at the position of the eyepiece 28 via the imaging lens 25 of the tube 26. Then, the first image I2 is visually observed as a sample image by the observer with the eyepiece 28.

The inverted microscope for industrial use shown in FIG. 2 will now be described. In this case, the structure of the main body 1 is entirely the same as that of FIG. 1, and its explanation will be omitted. In the inverted microscope for industrial use, the following additional units are mounted on the main body 1.

An illuminator tube 32 is inserted through, and supported by, the opening portion 1c provided at the leg portion 1a on the rear side of the main body 1. The illuminator tube 32 has a light source device 31 using a halogen lamp, etc., as incident-light illumination means. A semi-transparent mirror 33 is provided on the illuminator tube 32. The semi-transparent mirror 33 reflects illumination light, which has been horizontally guided from the light source device 31 to the illuminator tube 32, vertically upward. Specifically, the light source device 31, illuminator tube 32 and semi-transparent mirror 33 are generally called an incident-light illumination device. Illumination light from the light source device 31 is reflected by the semi-transparent mirror 33, and condensed on the observed sample 2 via the objective lens 4.

The reflection mirror 7 disposed in the bottom portion of the main body as in FIG. 1 reflects an imaging beam of the observed sample 2, which has outgone vertically downward by the objective lens 4 and the imaging lens 6, obliquely upward (45° in this case). Then, an intermediate image I1 is formed on the observation optical path 8.

The intermediate image I1 is made incident on a relay lens group 34. The relay lens group 34 is arranged inside an additional unit 35 provided on the front side of the main body 1. The optical axis of the relay lens group 34 agrees with the optical axis of the observation optical path 8. Also in the case shown in FIG. 2, a hole portion enough for the relay lens group 23 to enter the main body 1 is provided on the main body 1 side. A part of the relay lens group 23 enters the main body 1 side through the hole portion.

A semi-transparent mirror 36 as an optical element is disposed among the relay lens group 34. The semi-transparent mirror 36 reflects a part of beam relayed through the relay lens group vertically downward. A mirror 37 reflects the beam reflected by the semi-transparent mirror 36 horizontally forward. The beam reflected by the mirror 37 outgoes from a front port 38 provided on the front surface of the additional unit 35. The front port 38 is used for attaching image pickup means such as a photographic device and TV camera. Further, an image pickup optical system 39 is provided for forming a sample image I2 on an image pickup surface of a photographic device and TV camera, etc., to be attached to the front port 38.

A tube 41 having a tube lens 40 in the same manner as stated with respect to FIG. 1 is detachably attached to the additional unit 35. A binocular portion 43 having an eyepiece 42 is provided integrally on the tube 41. Thereby, an imaging beam from the imaging lens 40 can be observed as a sample image I2.

Further, a power supply unit 44 is provided on the rear side of the main body 1. The power supply unit 44 includes a power supply 45 which supplies power to the light source device 31.

In the inverted microscope for industrial use as described above, in addition to visual observation by the eyepiece 42 in the same manner as FIG. 1, it is possible to simultaneously pick up an image of the observed sample 2 by attaching a TV camera or digital camera, etc. to the front port 38.

An inverted microscope for industrial use shown in FIG. 3 will now be described. In FIG. 3, the structure of the main body 1 is entirely the same as that in FIG. 1, and its explanation is omitted. In the inverted microscope as shown in FIG. 3, the following additional units are mounted on the main body 1. Further, in FIGS. 2 and 3, like reference numerals denote like elements in the additional units.

A reflection mirror 51 disposed in the bottom portion of the main body 1 reflects an imaging beam of the observed sample 2, which has outgone vertically downward by the objective lens 4 and the tube lens 6, horizontally in the forward direction of the main body 1. The imaging beam of the observed sample 2 reflected by the reflection mirror 51 forms a first intermediate image I1 on an observation optical path 52 in the horizontal direction.

The first intermediate image I1 is incident into a relay lens group 53. The relay lens group 53 is arranged inside an additional unit 54 provided on the front side of the main body 1. The optical axis of the relay lens group 53 agrees with the optical axis of the observation optical path 52. Further, also in FIG. 3, a hole portion enough for the relay lens group 23 to enter the main body 1 is provided on the main body 1 side. A part of the relay lens group 23 enters the main body 1 side through the hole portion.

A mirror 55 is disposed among the relay lens group 53. The mirror 55 reflects a beam relayed through the relay lens group 53 vertically upward. Further, a semi-transparent mirror 56 is disposed on an optical path of the reflected light of the mirror 55. The semi-transparent mirror 56 transmits the beam relayed by the relay lens group 53, and reflects a part of the beam horizontally. The beam which has been transmitted through the semi-transparent mirror 56 forms is imaged as a second intermediate image I2 on the reflected light path. Further, the beam reflected by the semi-transparent mirror 56 outgoes from a front port 57 provided on the front surface of the additional unit 54. The front port 57 is used for attaching image pickup means, such as a photographic device and TV camera. Further, an image pickup optical system 58 is provided to form a sample image I3 on an image pickup surface of a photographic device or TV camera, etc. to be attached to the front port 57.

The second intermediate image I2 is made incident on a relay lens group 59. A semi-transparent mirror 60 is disposed among the relay lens group 59. The semi-transparent mirror 60 reflects a part of the beam relayed through the relay lens group 59 in a horizontal lateral direction (direction perpendicular to the surface of sheet). The light reflected by the semi-transparent mirror 60 outgoes from a side port 61 provided on a side surface of the additional unit 54. Image pickup mean such as a TV camera is attached to the side port 61. As described above, the side port 61 is used for picking up an image of the imaging beam reflected by the semi-transparent mirror 60 by a TV camera, etc.

The semi-transparent mirror 56 and 60 can be receded from the optical path at discretion by a known method. Further, a slot 62 is provided at a position of the second intermediate image I2. The slot 62 is used for inserting a framing reticle indicating a range reflected in a photographic device described below.

A tube 64 having a tube lens 63 is detachably attached to the additional unit 54 in the same manner as in FIG. 1. A binocular portion 66 having an eyepiece 65 is provided on the tube 64 integrally structure with the tube 64. Thereby, an imaging beam from the tube lens 63 can be observed as a sample image I3′.

In the inverted microscope for industrial use as shown in FIG. 3, in addition to visual observation by the eyepiece 65 in the same manner as FIG. 1, it is possible to simultaneously pick up an image of the observed sample 2 by attaching a TV camera and digital camera, etc. to both the front port 57 and the side port 61. By inserting/receding the semi-transparent mirror 56 and 60 in/from the optical path, it is possible to select the ratio of quantity of light between observation by the eyepiece 65, image pickup by the side port 61, and image pickup by the front port 57, according to necessity.

Further, it is possible to use a variable-power optical system such as a zoom optical system, as the relay lens group 53 contained in the additional unit 54. Using such a system enables the observer to magnify and reduce the image of the observed sample 2 picked up via the side port 61 and the front port 57 according to the observer's preference and necessity. Therefore, adopting a variable-power optical system such as a zoom optical system is convenient to adjust the magnification more finely than changing the magnifications of the objective lens 4.

As shown in FIGS. 1 to 3, the inverted microscope system according to the first embodiment uses the approximately concave main body 1 having the leg portions 1a and 1b in common in the inverted microscopes for biological and medical use and for industrial use. The main body 1 comprises the revolver 5 for holding the objective lenses 4, tube lens 6 for forming an intermediate image I1 of the observed sample 2 in cooperation with the objective lens 4, and the revolver stand 9 which holds the revolver 5 and is supported so as to be direct-acting vertically with respect to the main body 1. The main body 1 further comprises the rack 10 attached to the revolver stand 9, pinion shaft 11 which meshes with the rack 10, and focusing handles 12 provided coaxially with the pinion shaft 11. Further, the stage 3 is fixed on the front and rear leg portions 1a and 1b.

Therefore, according to the first embodiment, instead of manufacturing different inverted microscopes for respective uses, it is possible to use the common main body 1 as a basic function portion. Thereby, the whole manufacturing cost for plural kinds of microscopes can be reduced. Further, such a microscope can be flexibly applied to various uses. Furthermore, by using the main body 1 common to all these various inverted microscopes, it is possible to increase the number of production per part and reduce the kinds of parts, and thereby to manufacture the main body 1 having the basic function at low cost.

Furthermore, as stated with respect to each of FIGS. 1 to 3, after making the common main body having the basic function portion, additional units 24, 35 and 54 having different functions are properly used in combination with the main body according to necessity, and thereby an inverted microscope system which can be applied to various needs, such as biological use and industrial use.

Further, in FIG. 2, although the illuminator tube 32 for incident-light illumination is mounted on the opening portion 1c provided on the leg portion la, the tube 32 can be mounted in a space between the leg portions 1a and 1b, which is originally an opening portion, such that the tube 32 extends therefrom sideward (perpendicularly to the surface of sheet).

In the first embodiment, the reflection mirror 7 and the reflection mirror 51 are described as different mirrors. However, the invention is not limited to it, and the reflection mirrors 7 and 51 may be the same mirror with a variable angle (see FIG. 4). In such a case, it suffices that the reflection mirror is rotated in a direction of r with the central point 0. Thereby, the reflection angle of the reflection mirror can be set to a desired angle. Therefore, as shown in FIG. 4, a reflection mirror can be applied to two inverted microscopes, that is, V-shaped and V-shaped microscopes. Further, a mirror may be formed to move in the X direction shown in FIG. 4 so as to be removed from the optical path. By doing so, it is possible to obtain a sample image corresponding to the intermediate image I1 by disposing a camera, etc. below the main body 1. This structure of the mirror is also applicable to the following embodiments.

(Second Embodiment)

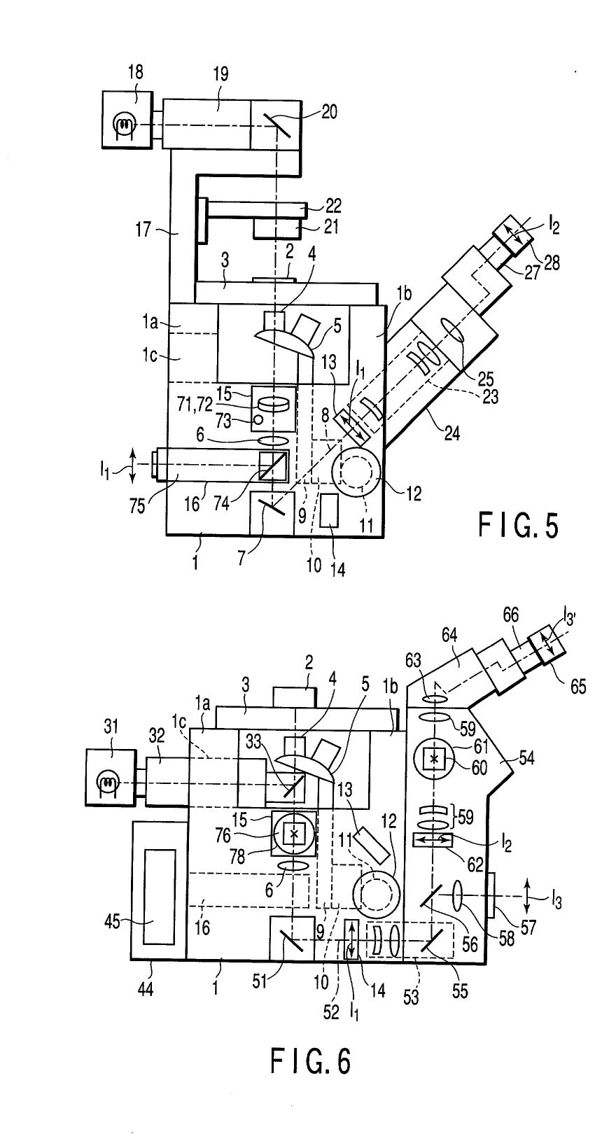

The inverted microscope system according to a second embodiment of the present invention will now be described with reference to FIGS. 5 and 6.

FIGS. 5 and 6 are diagrams each showing a schematic structure of an inverted microscope system according to the second embodiment. FIG. 5 is a diagram showing a structure made by adding option units to the inverted microscope shown in FIG. 1. FIG. 6 is a diagram showing a structure made by adding option units to the inverted microscope shown in FIG. 3.

In FIG. 5, two kinds of intermediate variable-power lenses 71 and 72 and inserting/removing mechanism 73 are added to the option unit adding space 15. The intermediate variable-power lenses 71 and 72 cooperate with the tube lens 6 to change the magnification of the magnified image of the observed sample 2 obtained by the objective lens 4. The inserting/removing mechanism 73 selectively inserts/removes the two kinds of intermediate variable-power lenses 71 and 72 into/from the optical path. Further, a semi-transparent mirror 74 and a back-port unit 75 are added to the option unit adding space 16. The semi-transparent mirror 74 reflects a part of an imaging beam outgoing from the tube lens 6 horizontally backward. The back-port unit 75 has a mount, to which a TV camera, etc., is attachable, on its rear end portion.

The other parts of FIG. 5 are entirely the same as those in FIG. 1, and explanations thereof are omitted.

According to the structure as shown in FIG. 5, it is possible to easily change the magnification of the intermediate image (primary image) I1 itself by the intermediate variable-power lenses 71 and 72, not relaying the intermediate image I1 of the observed sample 2. Therefore, it is possible to construct an inverted microscope adapted to biological use in which deterioration of image due to relay is not preferable.

Further, since a TV camera, etc. is provided on the rear side of the main body 1 with the back-port unit 75, no space is required on the front surface and side surfaces of the main body. Therefore, it is possible to effectively use the desktop space. In particular, a wide space is available on the side surface side of the main body, which is very effective when an attachment such as a manipulator is used in combination with the inverted microscope. Further, since an intermediate image (primary image) I1 can be directly picked up via the back-port unit 75, it is possible to obtain observation results with high accuracy.

In FIG. 6, a dichroic mirror 76, an IR tube lens (not shown), a mount 78, and an IR TV camera are added to the option unit adding space 15. The dichroic mirror 76 reflects only an infrared light component in a beam outgoing from the objective lens 4. The IR imaging lens images the beam reflected by the dichroic mirror 76. A TV camera is attachable to the mount 78.

By adopting such a structure, it is possible to easily construct an inverted microscope enabling IR observation, which is applied to industrial use, such as defect detection of metal materials.

(Third Embodiment)

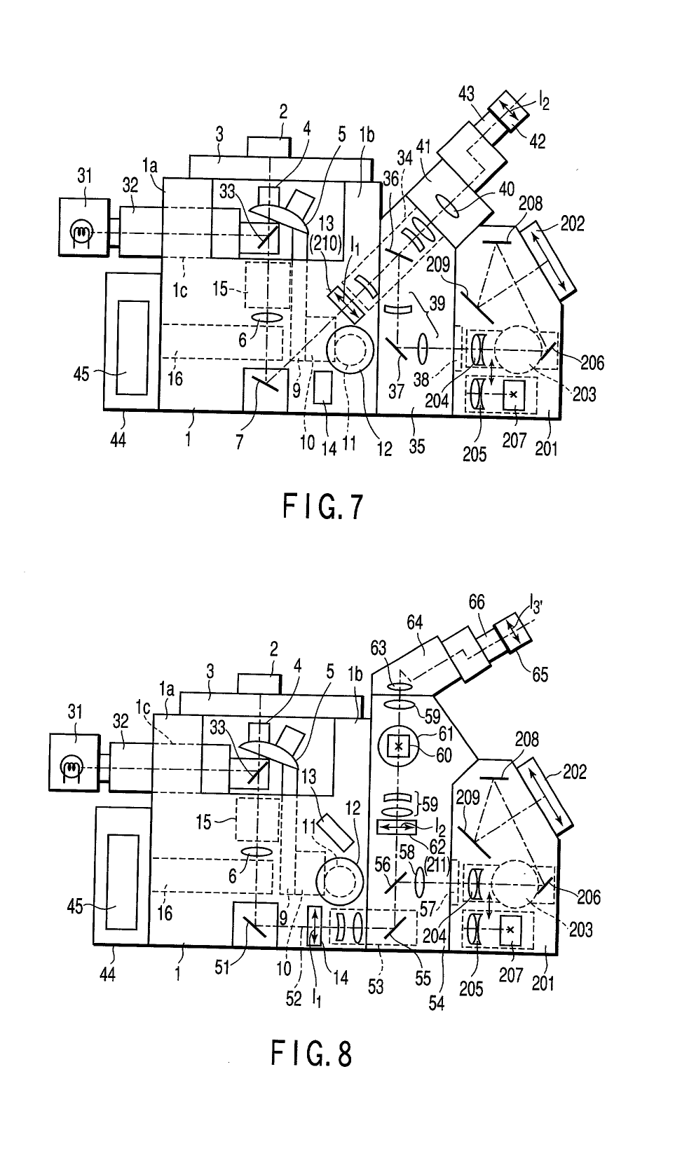

A third embodiment of the present invention will now be described with reference to FIGS. 7 and 8.

FIGS. 7 and 8 are diagrams each showing a schematic structure of an inverted microscope system according to the third embodiment. In the inverted microscope system according to the third embodiment, entirely the same photographic device is connected to each of the front port 38 and the front port 57 in the inverted microscopes shown in FIGS. 2 and 3. Further, the structures in FIGS. 7 and 8 other than the photographic device are the same as those in FIGS. 2 and 3 respectively, their explanations will be omitted with like components denoted by like reference numerals.

In the third embodiment, a photographic device 201 is attached to each of the front surfaces of the additional unit 35 shown in FIG. 2 and the additional unit 54 shown in FIG. 3, and covers the whole front surface.

A large-sized camera 202 and a 35 mm camera 203 are attached to the front surface and the side surface, respectively, of the photographic device 201. The large-sized camera 202 can take a photograph of a large size with length and breadth dimensions such as 4 inch×5 inch and 3 inch×4 inch. The 35 mm camera 203 can take a photograph of 35 mm size.

Two kinds of photographic lenses 204 and 205 are provided in the photographic device 201 such that they can be inserted in, and removed from, the optical path. The photographic lens 204 is a photographic lens for the large-sized camera 202. The photographic lens 205 is a photographic lens for the 35 mm camera 203. The photographic lens 204 for the large-size camera and a reflection mirror 206 are formed integrally. The photographic lens 205 for 35 mm camera and a reflection mirror 207 are formed integrally. The photographic lens 204 and the reflection mirror 206, and the photographic lens 205 and the reflection mirror 207 are alternatively placed in the optical path. Thereby, an image of the observed sample is selectively formed on film surfaces of the large-sized camera 202 and 35 mm camera 203 which are arranged on the front surface and side surface, respectively, of the photographic device 201. A beam which has passed through the photographic lens 204 and reflected by the reflection mirror 206 is further reflected by two reflection mirrors 208 and 209, and then reaches the large-sized camera 202. Therefore, a beam directed to the large-sized camera 202 in the photographic device 201 is imaged after three reflections in total. Further, a beam which has passed through the photographic lens 205 and reflected by the reflection mirror 207 reaches the 35 mm camera 203 without further reflection. Therefore, a beam directed to the 35 mm camera 203 in the photographic device 201 is imaged after only one reflection.

Further, FIG. 7 shows a photographic frame 210 showing a range reflected in the large-sized camera 202 and 35 mm camera 203 of the photographic device 201. The photographic frame 210 is inserted in the slot 13, and held insertably/removably with respect to the optical path.

FIG. 8 shows a photographic frame 211 similar to the frame 210, which shows a range reflected in the large-sized camera 202 and 35 mm camera 203 of the photographic device 201. The photographic frame 211 is inserted in the slot 62, and held insertably/removably with respect to the optical path.

Next, the operation of each of the inverted microscopes obtained by mounting the above photographic device 201 when taking photographs will now be described.

The objective lens 4 of a low magnification is selected by revolving the revolver 5. Next, the focusing handle 12 is rotated to focus on the observed sample 2. The revolver 5 is revolved to change the objective lens to the objective lens 4 of a high magnification. Then, if the observed sample becomes out of focus, the focusing handles 12 are slightly rotated to accurately focus on the sample. If the observed point is to be changed, an operation handle of the stage 3 is operated to shift the position of the observed sample 2 and bring a desired observed point into the field of view of the objective lens 4.

The photographic frame 210 or 211 showing the range picked up by the large-sized camera 202 or 35 mm camera 203 is inserted in the optical path. Then, the range picked up by a large-sized film or 35 mm film is checked. If the range to be picked up is proper, an exposure operation of the photographic device is performed. Thereby, taking a photograph is completed.

By adopting the above construction, it is possible to connect entirely the same photographic device to the front portions of the main bodies of microscopes having different structures. Therefore, there is no need to prepare a different dedicated photographic device for each kind of microscope. It is thus possible to realize an inverted microscope, with which a photographic device can be used in combination, at a low cost.

According to the embodiments of the present invention, it is possible to provide an inverted microscope system which can be flexibly applied to various uses.

An inverted microscope according to an aspect of the present invention is characterized by comprising: a microscope main body having an objective lens opposed to a sample, a primary image forming optical system which forms an intermediate image of the sample in cooperation with the objective lens, and focusing means for changing a relative distance between the sample and the objective lens and imaging the intermediate image of the sample at a predetermined position; illumination means which is detachable with respect to the microscope main body, for generating illumination light to the sample; and an additional unit which is detachable with respect to the microscope main body and includes a tube to observe the intermediate image of the sample.

Preferred manners according to an aspect of the present invention are as follows. The following manners may be applied separately, or applied in combination with each other according to necessity.

(1) The microscope main body further comprises an optical element which reflects an observation light from the sample outgoing from the objective lens in either an obliquely upward direction or a substantially horizontal direction, and the intermediate image is formed on an optical path to which the light is reflected by the optical element.

(2) The optical element comprises a first optical element which reflects a beam from the objective lens obliquely upward, and a second optical element which reflects the beam in a substantially horizontal direction, and any one of the first optical element and the second optical element is selectively attached to the microscope main body.

(3) A reflection angle of the optical element is variable.

(4) The optical element is attachable and detachable.

(5) The additional unit has a relay optical system for relaying the intermediate image of the sample to the tube.

(6) The additional unit further comprises an optical element which takes out a part of the beam of the intermediate image of the sample, relayed by the relay optical system, and a port to which image pickup means for picking up the sample image taken out via the optical element is attached.

Specifically, an inverted microscope system according to one aspect of the present invention comprises, for example, an objective lens opposed to a sample, a primary image forming optical system which forms an intermediate image of the sample in cooperation with the objective lens, focusing means for changing a relative distance between the sample and the objective lens, a focusing handle disposed on a side surface of the inverted microscope main body to operate the focusing means, and any one of a first optical element which reflects observation light of the sample obliquely upward and a second optical element which reflects the light in a substantially horizontal direction (or an optical element with a variable reflection angle). Further, if the inverted microscope is viewed from the side surface of the inverted microscope, the focusing handle is disposed in a region held between an optical path directed obliquely upward and an optical path directed in a substantially horizontal direction. By selectively attaching the first and second optical elements (or changing the reflection angle of an optical element), the observation light from the sample outgoes to any one of the obliquely upward optical path and the substantially horizontal optical path.

Further, the inverted microscope system comprises one of plural kinds of different additional units each having a relay optical system which relays an intermediate image formed by the primary image forming optical system of the inverted microscope main body, and a tube for observing a sample image relayed by the additional unit. Inverted microscopes for different uses can be constructed by selecting any one of the first and second optical elements and selecting any one of the additional units.

Furthermore, the plural kinds of additional units at least include a first additional unit which relays the intermediate image outgoing from the oblique optical path, and a second additional unit which relays the intermediate image outgoing from the substantially horizontal optical path.

As described above, according to the embodiments of the present invention, instead of manufacturing different inverted microscopes separately according to use, a microscope main body as a basic function portion is used in common. Thereby, manufacturing costs for the whole plural kinds of microscopes is reduced, and such a microscope can be flexibly applied to various uses.

Further, a plurality of optical systems obtained by changing only the relay optical system can be easily realized. Therefore, for example, it is possible to take out an image pickup optical path from the relay optical system which is generally used in industrial use, etc., while the microscope main body is used in common among plural kinds of microscopes including those for biological and medical use.

Furthermore, since a part of a beam of an intermediate image of the sample is taken out from the relay optical system to be relayed to a port, it is possible to pick up an image simultaneously with visual observation of the sample, by providing image pickup means, such as a TV camera and digital camera, on the port.

As described above, according to the present invention, instead of manufacturing various kinds of dedicated inverted microscope main bodies for various uses, such as biological and medical use and industrial use, a basic function portion of a microscope is used in common, and thereby manufacturing costs for the whole plural kinds of microscopes is reduced, and it is possible to realize an inverted microscope which can be flexibly applied to various uses.

Additional advantages and modifications will readily occur to those skilled in the art. Therefore, the present invention in its broader aspects is not limited to the specific details, respective devices, and illustrated examples shown and described herein. Accordingly, various modifications may be made without departing from the spirit or scope of the general inventive concept as defined by the appended claims and their equivalents.

What is claimed is:

1. An inverted microscope system comprising:
a microscope main body having an objective lens opposed to a sample, a primary image forming optical system which forms an intermediate image of the sample in cooperation with the objective lens, and focusing means for changing a relative distance between the sample and the objective lens and forming the intermediate image of the sample at a predetermined position;
illumination means which is detachable with respect to the microscope main body, for generating illumination light to the sample; and
an additional unit which is detachable with respect to the microscope main body and includes an observation tube to observe the intermediate image of the sample.

2. The inverted microscope system according to claim 1, wherein the additional unit having a relay optical system to relay the intermediate image of the sample to the observation tube.

3. The inverted microscope system according to claim 2, wherein the additional unit further comprising an optical element which takes out a part of a beam of the intermediate image of the sample relayed by the relay optical system, and a port to which image pickup means is attached, the image pickup means picking up a sample image taken out via the optical element.

4. The inverted microscope system according to claim 3, wherein the microscope main body further comprising an optical element which reflects observation light from the sample outgoing from the objective lens in any one of an obliquely upward direction and a horizontal direction, and the intermediate image being formed on an optical path of the light reflected by the optical element.

5. The inverted microscope system according to claim 4, wherein the additional unit having a relay optical system to relay the intermediate image of the sample to the observation tube.

6. The inverted microscope system according to claim 5, wherein the additional unit further comprising an optical element which takes out a part of a beam of the intermediate image of the sample relayed by the relay optical system, and a port to which image pickup means is attached, the image pickup means picking up a sample image taken out via the optical element.

7. The inverted microscope system according to claim 2, wherein the optical element including a first optical element which reflects a beam from the objective lens obliquely upward, and a second optical element which reflects the light in a substantially horizontal direction,
any one of the first optical element and the second optical element being selectively attached to the microscope main body.

8. The inverted microscope system according to claim 7, wherein the additional unit having a relay optical system to relay the intermediate image of the sample to the tube.

9. The inverted microscope system according to claim 9, wherein the additional unit further comprising an optical element which takes out a part of a beam of the intermediate image of the sample relayed by the relay optical system, and a port to which image pickup means is attached, the image pickup means picking up a sample image taken out via the optical element.

10. The inverted microscope system according to claim 2, wherein the optical element having a variable reflection angle.

11. The inverted microscope system according to claim 10, wherein the additional unit having a relay optical system to relay the intermediate image of the sample to the observation tube.

12. The inverted microscope system according to claim 11, wherein the additional unit further comprising an optical element which takes out a part of a beam of the intermediate image of the sample relayed by the relay optical system, and a port to which image pickup means is attached, the image pickup means picking up a sample image taken out via the optical element.

13. The inverted microscope system according to claim 2, wherein the optical element being detachable.

14. The inverted microscope system according to claim 13, wherein the additional unit having a relay optical system to relay the intermediate image of the sample to the observation tube.

15. The inverted microscope system according to claim 14, wherein the additional unit further comprising an optical element which takes out a part of a beam of the intermediate image of the sample relayed by the relay optical system, and a port to which image pickup means is attached, the image pickup means picking up a sample image taken out via the optical element.
